(19) United States
(12) Patent Application Publication
(10) Pub. No.: US 2013/0115072 A1
(43) Pub. Date: May 9, 2013

(54) ALLOYS FOR BOND COATINGS AND ARTICLES INCORPORATING THE SAME

(71) Applicants: Kivilcim Onal, Greer, SC (US); David Vincent Bucci, Simpsonville, SC (US); Canan Uslu Hardwicke, Simpsonville, SC (US); David Austin Wark, West Sand Lake, NY (US)

(72) Inventors: Kivilcim Onal, Greer, SC (US); David Vincent Bucci, Simpsonville, SC (US); Canan Uslu Hardwicke, Simpsonville, SC (US); David Austin Wark, West Sand Lake, NY (US)

(73) Assignee: GENERAL ELECTRIC COMPANY, Schenectady, NY (US)

(21) Appl. No.: 13/292,382

(22) Filed: Nov. 9, 2011

(51) Int. Cl. F03B 11/02; B21D 39/00; C22C 30/00; B05B 1/00; C22C 19/05; C22C 19/07; B32B 15/04; F04D 29/38

(52) U.S. Cl. 415/208.1; 428/457; 428/633; 416/241 R; 239/589; 428/652; 428/678; 420/591; 420/443; 420/437; 420/588

(57) ABSTRACT

In an exemplary embodiment, a high temperature oxidation and hot corrosion resistant MCrAlX alloy is disclosed, wherein M comprises cobalt and X comprises, by weight of the alloy, from about 0.001 percent to less than 0.19 percent yttrium. In these alloys, X may also optionally include silicon, including, by weight of the alloy, up to about 1.5 percent. In another exemplary embodiment, a coated article is disclosed. The coated article includes a substrate having a surface. The article also includes a bond coat disposed on the surface. The bond coat comprises a high temperature oxidation and hot corrosion resistant MCrAlX alloy, wherein M comprises cobalt and X comprises, by weight of the alloy, from about 0.001 percent to less than 0.19 percent yttrium.

### BACKGROUND OF THE INVENTION

The subject matter disclosed herein relates to metallic alloy compositions suitable for use in high temperature environments, and more particularly to metallic alloy compositions suitable for use as articles or bond coat materials in high temperature environments to provide protection from oxidation and hot corrosion.

In harsh environments such as a turbine engine, metallic overlay or bond coatings (i.e. MCrAlY and/or aluminides) and thermal barrier coatings (TBCs) protect the underlying metal alloy substrate against heat and the corrosive and oxidizing environment of the hot gases. The TBC provides a heat reducing barrier between the hot combustion gases and the metal alloy substrate, and can prevent, mitigate, or reduce potential heat and corrosion induced damage to the substrate.

MCrAlY alloys are a family of high temperature coatings, wherein M is selected from one or a combination of iron, nickel and cobalt; and Cr is chromium, Al is aluminum, and Y is yttrium. These include MCrAlY coatings with gamma and beta phases in the alloy microstructures. Various alloying elements, such as Si, Hf, Pd and Pt, have been added to gamma/beta MCrAlY alloys to improve oxidation and/or hot corrosion resistance, but this may lead to reduction in strain tolerance of the bond coat materials and may also result in reduction of spallation life of the coating systems in which they have been employed, particularly those which include TBCs.

Therefore, a need exists to provide bond coat materials that improve the spallation resistance of protective coating systems in which they are employed, particularly those which employ TBCs.

### BRIEF DESCRIPTION OF THE INVENTION

According to one exemplary embodiment, a high temperature oxidation and hot corrosion resistant MCrAlX alloy, wherein M comprises cobalt and X comprises, by weight of the alloy, from about 0.001 percent to less than 0.19 percent yttrium.

According to another exemplary embodiment, a coated article is disclosed. The coated article includes a substrate having a surface. The article also includes a bond coat disposed on the surface. The bond coat comprises a high temperature oxidation and hot corrosion resistant MCrAlX alloy, wherein, by weight of the alloy, M comprises cobalt and X comprises, by weight of the alloy, from about 0.001 percent to less than 0.19 percent yttrium.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic sectional view of exemplary embodiments of articles as disclosed herein;

FIG. 2 is a sectional view of a surface region of an exemplary embodiment of a substrate in the form of a turbine blade and bond coating as disclosed herein;

FIG. 3 is a second exemplary embodiment of a substrate in the form of a turbine blade and bond coating as disclosed herein;

FIG. 4 is a third exemplary embodiment of a substrate in the form of a turbine blade and bond coating as disclosed herein;

FIG. 5 is a fourth exemplary embodiment of a substrate in the form of a turbine blade and bond coating as disclosed herein;

FIG. 6 is a fifth exemplary embodiment of a substrate in the form of a turbine blade and bond coating as disclosed herein; and

FIG. 7 is a sixth exemplary embodiment of a substrate in the form of a turbine blade and bond coating as disclosed herein.

The detailed description explains embodiments of the invention, together with advantages and features, by way of example with reference to the drawings.

### DETAILED DESCRIPTION OF THE INVENTION

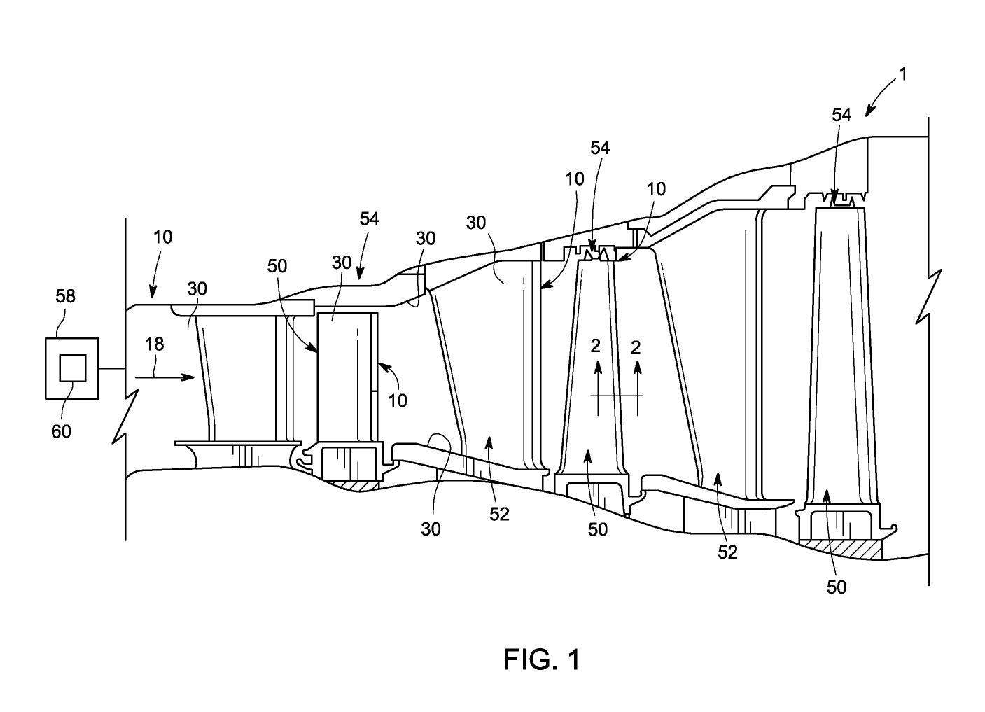

Referring to FIGS. 1-7, a high temperature oxidation and hot corrosion resistant MCrAlX alloy 100 is disclosed herein. The MCrAlX alloy 100 may be used for any desired application, but is particularly suited for use as a bond coat 110 material for various high temperature articles, particularly various components 10 of a turbine engine 1, and even more particularly for use as a bond coat 110 material for various components 10 of an industrial gas turbine that comprise the hot gas flow path 18 and surfaces 30 that are exposed to the high temperature combustion gases that flow through this path. These bond coat 110 materials are particularly well-suited for use with various turbine blades (or turbine buckets) 50, but are also well suited for use with other components, including vanes (or turbine nozzles) 52, shrouds 54, 58, fuel nozzles 60, transition pieces, combustor liners and the like, and including subcomponents and subassemblies of these components. For example, a combustor 58 generally comprises an assembly of a plurality of components, including various subassemblies, and bond coat 110 materials may be incorporated on any or all of the components and subassemblies. The MCrAlX alloy 100 may be applied as an overlay bond coat 110 or bond coating in any of the applications mentioned to any suitable substrate 120, particularly various superalloy substrates 120, including Co-based, Ni-based or Fe-based superalloy substrates, or combinations thereof. In an exemplary embodiment, the MCrAlX alloys 100 disclosed herein may be used, for example, as a bond coat 110 on the pressure or suction surface of the airfoil section or blade tip of a gas turbine blade 50 as illustrated in FIG. 1.

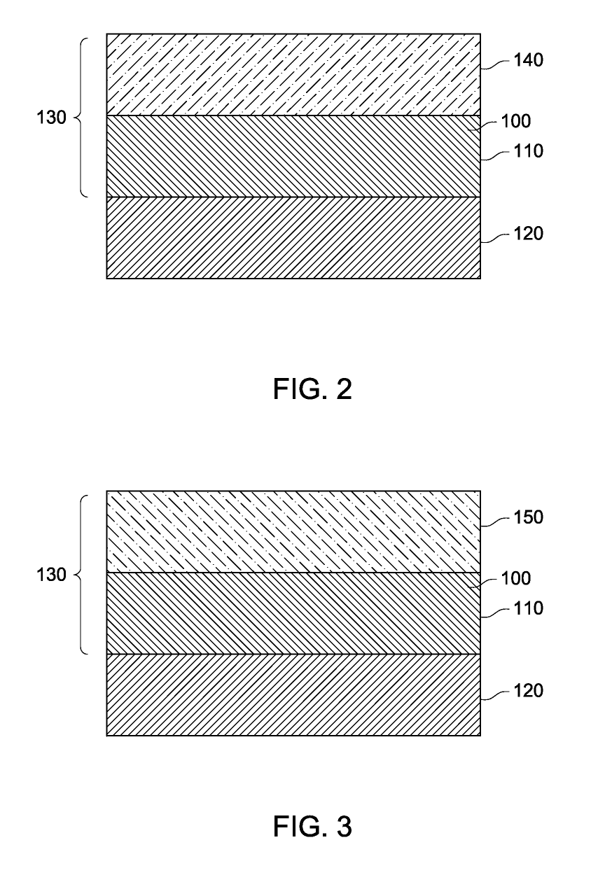

In an exemplary embodiment, a surface 30 of a component 10, such as a turbine blade 50, is protected by the bond coat 110 material as a metallic protective coating layer, as illustrated in greater detail in FIG. 2, which depicts an enlargement of a section through the surface 30 of a component 10, such as a turbine blade 50. The surface 30 may include any portion of the component 10 on which it is desirable to provide a bond coat 110 material to protect the substrate 120 from oxidation or hot corrosion, or both of them, including surfaces 30 that comprise that hot gas flow path 18 and are directly exposed to the hot combustion gases that flow through this path, as well as other surfaces, including those that are not directly exposed to the hot combustion gases, but which may be exposed to high temperatures resulting from these gases. In one exemplary embodiment, the surface 30 may include the surface of the airfoil section or blade tip of a turbine blade 50. Bond coat 110 may be used by itself to protect the surface 30 as shown in FIG. 7, or may be used in conjunction with other high temperature materials, including other high temperature coating materials, to provide a protective system 130 of coating layers as described herein, wherein the bond coat 110 may be used, for example, as an under layer or an inner layer or an outer layer, or a combination thereof, in such a system.

Protective system 130 may include bond coat 110 as an under layer as part of a combination of coating layers that also includes one or more thermal barrier coating (TBC) layer 140, or one or more aluminide coating layer 150, or one or more other bond coat layers, or a combination thereof In an exemplary embodiment, as illustrated in FIG. 2, protective system 130 may include a bond coat 110 as an oxidation and hot corrosion resistant under layer for at least one TBC layer 140, wherein the bond coat 110 is disposed on the surface 30 of a substrate 120, such as a superalloy substrate, and the at least one TBC layer 140 is disposed on the bond coat 110 and may be subject to exposure to the hot combustion gas.

In another exemplary embodiment, as illustrated in FIG. 3, protective system 130 may include a bond coat 110 as an oxidation and hot corrosion resistant under layer for at least one aluminide layer 150, wherein the bond coat 110 is disposed on the surface 30 of a substrate 120, such as a superalloy substrate, and the at least one aluminide layer 150 is disposed on the bond coat 110 and may be subject to exposure to the hot combustion gas.

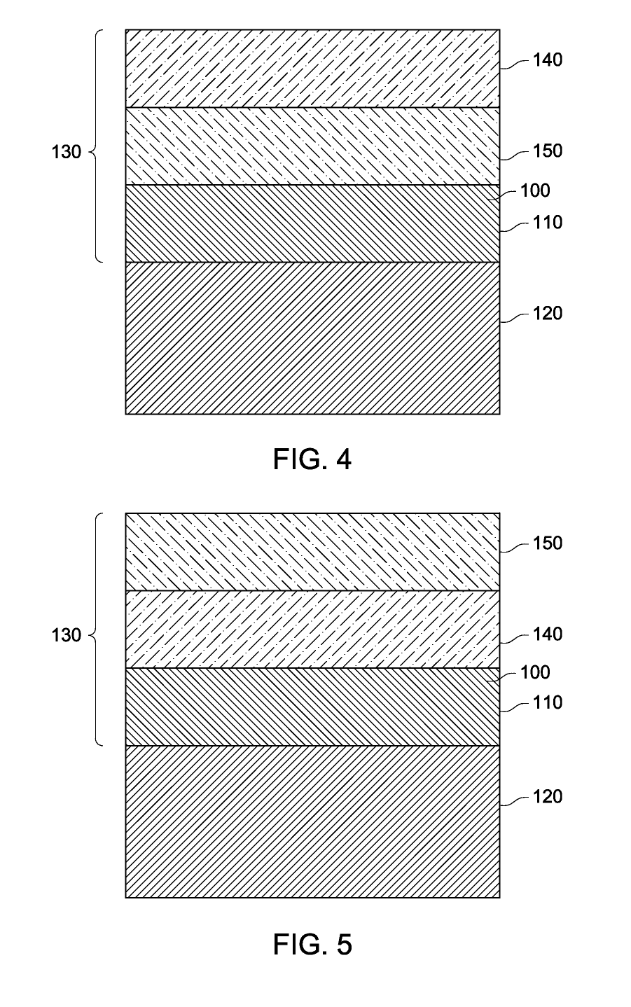

In yet another exemplary embodiment, as illustrated in FIG. 4, protective system 130 may include a bond coat 110 as an oxidation and hot corrosion resistant under layer for an aluminide layer 150 and a TBC layer 140, wherein the bond coat 110 is disposed on the surface 30 of substrate 120, the at least one aluminide layer 150 is disposed on the bond coat 110 and the at least one TBC layer 140 is disposed on the aluminide layer 150 and may be subject to exposure to the hot combustion gas.

In a further exemplary embodiment, as illustrated in FIG. 5, protective system 130 may include a bond coat 110 as an oxidation and hot corrosion resistant under layer for a TBC layer 140 and an aluminide layer 150, wherein the bond coat 110 is disposed on the surface 30 of superalloy substrate 120, the at least one TBC layer 140 is disposed on the bond coat 110 and the at least one aluminide layer 150 is disposed on the TBC layer 140 and may be subject to exposure to the hot combustion gas.

Protective system 130 may also include bond coat 110 as an inner layer as part of a combination of coating layers that also includes one or more thermal barrier coating (TBC) layer 140, or one or more aluminide layer 150, or a combination thereof For example, in exemplary embodiments, the protective systems 130 of FIGS. 2-5 may optionally include at least one aluminide layer 150 or another bond coat layer disposed on the substrate 120, between the substrate and the bond coat 110. Otherwise, the arrangement of the bond coat 110 layer, aluminide layer 150 and TBC layer 140 is as described above in FIGS. 2-5.

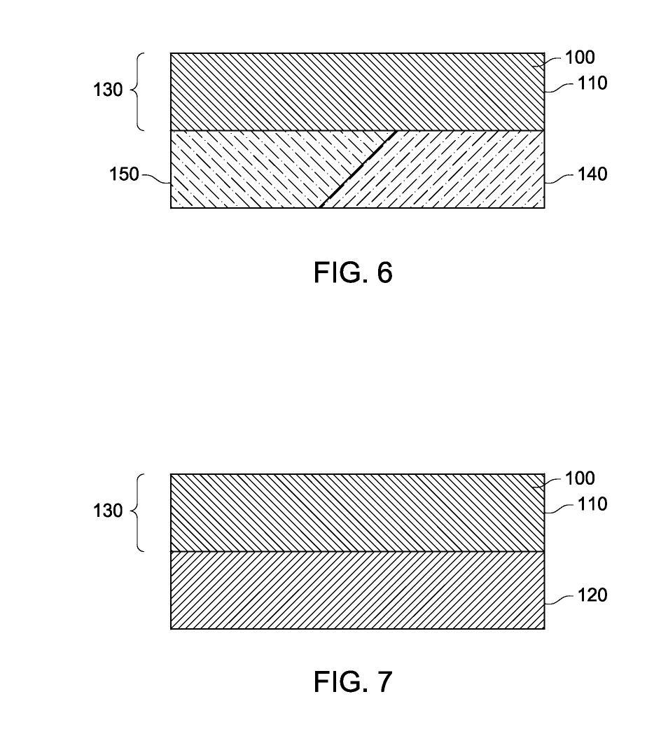

In yet another exemplary embodiment, as illustrated in FIG. 6, protective system 130 may include bond coat 110 as an outer layer as part of a combination of coating layers that also includes one or more thermal barrier coating (TBC) layer 140, or one or more aluminide layer 150, or a combination thereof. Other combinations of one or more bond coat 110 as an outer layer, in combination with one or more TBC layer 140 or one or more aluminide layer 150, or another bond coat layer, or a combination thereof, are also possible.

In a further exemplary embodiment, as illustrated in FIG. 7, protective system 130 may include just bond coat 110 as an outer layer, not in combination with other coating layers.

The protective systems 130 described above, including those that include bond coat 110 alone, include at least one bond coat 110 layer. In one embodiment, the bond coat 110 includes an alloy, and more particularly a superalloy, that comprises cobalt, nickel or iron, or any combination thereof, including cobalt-based, nickel-based or iron-based superalloys. In another embodiment, the bond coat 110 includes an alloy, and more particularly a superalloy, that comprises cobalt or nickel, or a combination thereof, including cobalt-based, nickel-based, cobalt-nickel-based or nickel-cobalt-based superalloys. Of these, alloys where the bond coat 110 comprises a cobalt-based, cobalt-nickel-based or nickel-cobalt -based superalloy bond coat material provide a good combination of high temperature oxidation resistance, TBC spallation resistance and ductility. As used herein, a metal-based (e.g., cobalt, nickel or iron)) means that the named metal (e.g., cobalt-based) is the primary constituent of the alloy, by weight. Where more than one metal (e.g., metal1-metal2-based) is used, the metals are listed in descending order by weight of the alloy. For example, a cobalt-nickel-based alloy means that cobalt and nickel are the primary alloy constituents, by weight, with the weight fraction of cobalt being larger than that of nickel; and a nickel-cobalt-based alloy means that nickel and cobalt are the primary alloy constituents, by weight, with the weight fraction of nickel being larger than that of cobalt.

In one embodiment, the cobalt-based, cobalt-nickel-based or nickel-cobalt-based superalloy bond coat material comprises an MCrAlX alloy 100, where M includes cobalt, and may also optionally include nickel, and where X includes yttrium from about 0.001 percent to less than 0.19 percent by weight of the alloy and may also optionally include silicon or germanium, or a combination thereof The MCrAlX alloys 100 disclosed generally employ reduced amounts of yttrium compared to existing MCrAlY bond coat alloys used for turbine engine applications, which have a nominal composition that includes 0.3 percent Y, and where Y is known to range from 0.19 to 1.0 percent. The reduced amounts of yttrium advantageously provide improved oxidation resistance and increased TBC spallation resistance for these alloys when used in protection systems 130 that also include a TBC layer 140. The MCrAlX alloys 100 disclosed herein also may employ increased amounts of aluminum as compared to existing MCrAlY bond coat alloys, such that described herein, which advantageously further improves the oxidation resistance as compared to existing bond coat alloys. The MCrAlX alloys 100 disclosed herein also may optionally employ germanium, which is not present in existing MCrAlY bond coat alloys, such as that described above, which also advantageously improves the ability to retain the beta phase for longer exposure times in turbine engine applications as described herein. The MCrAlX alloys 100 disclosed herein also may optionally employ silicon, which advantageously improves oxidation resistance and TBC spallation life.

In an exemplary embodiment, the MCrAlX alloy 100 is a cobalt-based, cobalt-nickel based or nickel-cobalt-based MCrAlX alloy having a microstructure that includes gamma and beta phases wherein, by weight of the alloy, M comprises cobalt in an amount of at least about 27 percent and X comprises yttrium in an amount of about 0.001 to less than 0.19 percent by weight of the alloy. More particularly, yttrium may be present in an amount, by weight of the alloy, from about 0.001 to about 0.18 percent, and even more particularly, from about 0.01 to about 0.18 percent, and yet even more particularly from about 0.02 to about 0.15 percent. The MCrAlX alloy 100 may also optionally include germanium in an amount, by weight of the alloy, from about 0.001 to about 1.5 percent, and more particularly from about 0.01 to about 1.5 percent, and even more particularly, from about 0.2 to about 1.5 percent. The MCrAlX alloy 100 may also optionally include silicon in an amount, by weight of the alloy, of up to about 1.5 percent, and more particularly from about 0.01 to about 1.5 percent, and even more particularly from about 0.1 to about 1.5 percent. In another exemplary embodiment, the MCrAlX alloy 100 may also be described as comprising a cobalt-nickel-based alloy, and may include, by weight of the alloy, from about 20.0 to about 82.0 percent nickel, from about 10.0 to about 28.0 percent chromium, from about 5.0 to about 15.0 percent aluminum, and yttrium and optionally germanium or silicon, or a combination thereof, in the amounts described above, including from about 0.001 to less than 0.19 percent yttrium, about 0.001 to about 1.5 percent germanium and up to about 1.5 percent silicon, and the balance cobalt and incidental impurities. The incorporation of yttrium in the amounts indicated increases the resistance of the MCrAlX alloy 100 to oxidation and TBC spallation compared to, for example, existing bond coat alloys as described herein, and includes yttrium in a nominal amount of 0.3 percent, and is known to range in commercial practice from 0.19 to 1.0 percent by weight of the alloy, and does not include germanium or silicon. For example, the MCrAlX alloys 100 described herein increase the spallation resistance of a protective system that includes a bond coat 110 of the alloy applied to a superalloy substrate 120 as an under layer for a TBC layer 140. Thus, for a given operating temperature, the spallation resistance of a protection system 130 comprising the MCrAlX alloys 100 disclosed herein as a bond coat 110 material under a TBC layer 140 was greater than the resistance of a protection system comprising bond coat alloys having higher amounts of yttrium under the same TBC layer 140. From another perspective, the use of the MCrAlX alloys 100 disclosed herein also has the capability to enable the protection system 130 described, i.e., bond coat 110/TBC coating layer 140, to achieve about the same spallation resistance at an average operating temperature that was about 22° F. or more higher than that of a protection system comprising the comparative alloys described herein and TBC layer 140. Therefore, the MCrAlX alloys 100 described herein improve the spallation resistance sufficiently to enable longer operating lifetimes at the same operating temperature or the similar operating lifetimes at higher operating temperatures. When used in the amounts disclosed herein, yttrium in the MCrAlX protective systems 130 disclosed herein improves oxidation resistance by delaying alumina spallation. The operating lifetime of protective systems 130 that employ bond coat 110 as an under layer for a TBC layer 140 is up to about four (4) times greater than the operating lifetime of the comparative bond coat alloys described herein.

In another exemplary embodiment, the MCrAlX alloys 100 disclosed herein may also optionally include, by weight of the alloy, germanium in an amount from about 0.001 to about 1.5 percent or silicon in an amount up to about 1.5 percent.

The incidental impurities may include those incidental to the processing of the individual alloy constituents described herein, particularly those known to be incidental to cobalt-based or nickel-based superalloys comprising these constituents, and more particularly to cobalt-nickel-based or nickel-cobalt-based alloys comprising these constituents. An example of an incidental impurity is sulfur. The amount of sulfur will preferably be controlled to less than about 100 ppm by weight of the alloy.

The bond coat 110 material may have a composition different from that of the substrate 120, or may have the same composition. The bond coat 110 may have any suitable thickness. In an exemplary embodiment, the bond coat 110 material may have a thickness of 0.0005 inch to about 0.050 inch In other embodiments, such as a turbine airfoil material, the thicknesses may be less or greater depending on the application. The MCrAlX alloys 100 disclosed herein may be used in any suitable form, including as alloy used to form an entire article of the types disclosed herein, or as a bond coat 110 material. The MCrAlX alloys may be formed by any suitable method, including various vacuum melting methods, and particularly melting methods employed for various superalloys, particularly cobalt-based, cobalt-nickel-based, nickel-based or nickel-cobalt-based superalloys. The bond coat 110 material may be applied by vapor deposition, slurry deposition, or any thermal spray process including but not limited to high velocity oxygen fuel spraying (HVOF), high velocity air fuel spraying (HVAF), vacuum plasma spray (VPS), air plasma spray (APS), ion plasma deposition (IPD), electron-beam physical vapor deposition (EBPVD) and cold spray methods.

The protective system 130 may also include an aluminide layer 150 disposed relative to the bond coat 110 material and other coatings as described herein. The aluminide layer 150 may include any suitable aluminide, including a diffusion aluminide such as a simple diffusion aluminide or a complex diffusion aluminide, such as a platinum aluminide. The aluminide layer 150 may have any suitable thickness, and in an exemplary embodiment, may have a thickness from about 0.0005 inch to about 0.003 inch thick.

The protective system 130 may also include a TBC layer 140 disposed relative to the bond coat 110 material and other coatings as described herein. Any suitable thermal barrier layer 140 may be used, including a dense vertically microcracked (DVM) ceramic TBC layer 140. The TBC layer 140 may have any suitable thickness, and in an exemplary embodiment, may have a thickness from about 0.005 inch to about 0.080 inch.

The terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Furthermore, unless otherwise limited all ranges disclosed herein are inclusive and combinable (e.g., ranges of “up to about 25 weight percent (wt. %), more particularly about 5 wt. % to about 20 wt. % and even more particularly about 10 wt. % to about 15 wt. %” are inclusive of the endpoints and all intermediate values of the ranges, e.g., “about 5 wt. % to about 25 wt. %, about 5wt. % to about 15 wt. %”, etc.). The use of “about” in conjunction with a listing of constituents of an alloy composition is applied to all of the listed constituents, and in conjunction with a range to both endpoints of the range. Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments.

It is to be understood that the use of “comprising” in conjunction with the alloy compositions described herein specifically discloses and includes the embodiments wherein the alloy compositions “consist essentially of” the named components (i.e., contain the named components and no other components that significantly adversely affect the basic and novel features disclosed), and embodiments wherein the alloy compositions “consist of” the named components (i.e., contain only the named components except for contaminants which are naturally and inevitably present in each of the named components).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A high temperature oxidation and hot corrosion resistant MCrAlX alloy, wherein M comprises cobalt and X comprises, by weight of the alloy, from about 0.001 percent to less than 0.19 percent yttrium.

2. The alloy of claim 1, wherein yttrium comprises from about 0.001 percent to about 0.18 percent by weight of the alloy.

3. The alloy of claim 1, wherein yttrium comprises from about 0.01 percent to less than 0.15 percent by weight of the alloy.

4. The alloy of claim 1, wherein yttrium comprises from about 0.02 percent to about 0.10 percent by weight of the alloy.

5. The alloy of claim 1, wherein yttrium comprises from about 0.06 to less than 0.19 percent by weight of the alloy.

6. The alloy of claim 1, wherein X further comprises up to about 1.5 percent silicon by weight of the alloy.

7. The alloy of claim 1, wherein X further comprises from about 0.01 percent to about 1.5 percent silicon by weight of the alloy.

8. The alloy of claim 1, wherein M further comprises nickel.

9. The alloy of claim 1, wherein the alloy comprises, by weight of the alloy, from about 20.0 to about 82.0 percent nickel, from about 10.0 to about 28.0 percent chromium, from about 5.0 to about 15.0 aluminum, X comprising from about 0.001 to less than 0.19 percent yttrium, and the balance cobalt and incidental impurities.

10. The alloy of claim 1, wherein the alloy comprises, by weight of the alloy, from about 20.0 to about 82.0 percent nickel, from about 10.0 to about 28.0 percent chromium, from about 5.0 to about 15.0 aluminum, X comprising from about 0.001 to less than 0.19 percent yttrium and from about 0.001 percent to about 1.5 percent silicon, and the balance cobalt and incidental impurities.

11. The alloy of claim 1, wherein the alloy is a cobalt-based alloy comprising gamma and beta phases.

12. A coated article, comprising:
a substrate having a surface; and
a bond coat disposed on the surface, the bond coat comprising a high temperature oxidation and hot corrosion resistant MCrAlX alloy, wherein, by weight of the alloy, M comprises cobalt and X comprises from about 0.001 percent to less than 0.21 percent yttrium.

13. The coated article of claim 12, wherein X further comprises silicon in an amount up to about 1.5 percent by weight of the alloy.

14. The coated article of claim 12, wherein the alloy comprises, by weight of the alloy, from about 20.0 to about 82.0 percent nickel, from about 10.0 to about 28.0 percent chromium, from about 5.0 to about 15.0 percent aluminum, X comprising from about 0.001 to less than 0.19 percent yttrium, and the balance cobalt and incidental impurities.

15. The coated article of claim 12, wherein the alloy comprises, by weight of the alloy, from about 20.0 to about 82.0 percent nickel, from about 10.0 to about 28.0 percent chromium, from about 5.0 to about 15.0 percent aluminum, X comprising from about 0.001 to less than 0.19 percent yttrium and from about 0.01 to about 1.5 percent silicon, and the balance cobalt and incidental impurities.

16. The coated article of claim 12, wherein the yttrium comprises from about 0.001 to about 0.18 percent by weight of the alloy.

17. The coated article of claim 12, wherein M further comprises nickel.

18. The coated article of claim 12, further comprising a thermal barrier coating disposed on the bond coat.

19. The coated article of claim 12, further comprising an aluminide coating disposed on a surface of the bond coat away from the substrate or disposed between the substrate and the bond coat, or both.

20. The coated article of claim 19, wherein the aluminide coating is disposed on the surface of the bond coat away from the substrate, and further comprising a thermal barrier coating disposed on the aluminide coating.

21. The coated article of claim 12, wherein the substrate comprises an Fe-based, Ni-based or Co-based superalloy, or a combination thereof

22. The coated article of claim 12, wherein the substrate comprises a turbine blade, vane, shroud, nozzle, combustor or fuel nozzle.

23. A high temperature oxidation and hot corrosion resistant MCrAlX alloy, wherein M comprises cobalt, nickel or iron, or any combination thereof, and X comprises, by weight of the alloy, from about 0.001 percent to less than 0.19 percent yttrium.
